(19) United States
(12) Patent Application Publication
(10) Pub. No.: US 2009/0217327 A1
(43) Pub. Date: Aug. 27, 2009

(54) VIDEO-ON-DEMAND SYSTEM

(76) Inventor: Satoshi NAGANO, Kunitachi (JP)

Correspondence Address: MATTINGLY & MALUR, P.C., 1800 DIAGONAL ROAD, SUITE 370, ALEXANDRIA, VA, 22314, US

(21) Appl. No.: 12/366,087

(22) Filed: Feb. 5, 2009

(30) Foreign Application Priority Data
Feb. 21, 2008 (JP) 2008-039733

(51) Int. Cl. H04N 7/173

(52) U.S. Cl. 725/87

(57) ABSTRACT

A video-on-demand system in which the plurality of program televising time zones of an identical program is presented to a user beforehand, and the user registers his/her view desiring time zone beforehand. A price which is altered in accordance with the number of simultaneous viewers, and the number of view desiring users are presented to a user. For example, for the pursuit of the profit of an enterpriser, as the number of viewers becomes larger, the price is lowered more to increase the number of viewers still further. On the other hand, the presented price is altered by predetermined rules in order that the viewers may not increase excessively, thereby to lower a program televising quality in excess of the capability of the system. The number of users in a program televising time zone is controlled on an economy principle, whereby the loads of the system is leveled.

### BACKGROUND OF THE INVENTION

1. Field of the Invention

The present invention relates to a video-on-demand system.

More particularly, it relates to a video-on-demand system of joint purchase type which realizes video on demand or near video on demand where a user's desired program can be viewed at a user's desired time by a television receiver or the like connected to a network.

2. Description of the Related Art

In a prior-art video-on-demand scheme, when the number of simultaneous use users, for example, exceeds the maximum capability of a system, the degradations of a video quality, such as the frame omission and freeze of a view image, have been sometimes incurred.

The technique of Patent Document 1 (being JP-A-2003-333574) is intended to solve the problem, by limiting the number of times or the time period of trick plays (rewind, fast feed, etc.) which a user can perform, for example, when he/she views a video-on-demand program. Also, the technique of Patent Document 2 (being JP-A-2003-339001) is intended to solve the problem, by the display of a user congestion degree in each use time zone, or use reservations which do not depend upon view programs.

Patent Document 3 (being JP-A-2001-290722) discloses a technique wherein appropriate transfer means is selected in accordance with, for example, the number of expected persons to whom a content is to be delivered, and a delivery cost at that time is offered to an information provider.

### SUMMARY OF THE INVENTION

In the prior-art video-on-demand scheme, video contents are accumulated in a central video server device, to which a plurality of users are connected through a network. When the number of the simultaneous use users exceeds the maximum capability of a system in a case where access requests have been simultaneously made from the plurality of users to the video server, there have been such problems that the frame omission and the freeze of a view image and the like degradations of a video quality are incurred.

Besides, in the prior-art video-on-demand scheme, the identical content is provided at an identical price irrespective of the number of simultaneous viewers and view time zones. Therefore, the concentration of the simultaneous use users as stated before occurs, and the requests of view desiring persons cannot be met in some cases. This has become the loss of an income chance for a service enterpriser.

Besides, in order to enlarge the profit of the service enterpriser, it is considered to increase the users. On the other hand, however, the number of the users might exceed the capability of the system.

With the technique of Patent Document 1, the limitation of the number of times or the time period of the trick plays (rewind, fast feed, etc.) incurs the lowering of user's convenience. Further, the display of the user congestion degree of each time zone does not have concrete means for positively controlling user congestion.

Besides, Patent Documents 1 and 2 disclose means with which a viewer can reserve a view desiring time zone by a use reservation, but concrete means for distributing the loads of users is not provided.

According to Patent Document 3, the information provider can select an appropriate line and set a price on the basis of the offered information items. However, the information items depend upon a view expectation based on the profile of the person to whom the content is to be delivered (deliveree), etc., and a high uncertainty is involved. Besides, there is not provided means concerning the maximization of the income of the information provider, such as for the increase of the number of the deliverees as is based on the decrease of the price dependent upon the number of reserving persons, etc.

In view of the above drawbacks, the present invention has for its object to enlarge the profit of an enterpriser by increasing the number of the users of a video-on-demand system, and to prevent a quality from lowering due to the excess of the capability of the system. Besides, the invention has for its object to distribute users and level the loads of a system in such a way that a plurality of program televising time zones are presented to a user beforehand, and that the user registers his/her view desiring televising time zone beforehand from among the presented candidate time zones.

Another object of the invention is to provide a system in which prices that are altered in accordance with the numbers of simultaneous viewers, and the numbers of view desiring users are presented to users, and in which the users can change into economically advantageous televising time zones. Still another object of the invention is to provide a system in which the numbers of users in program televising time zones can be controlled by the price settings of a provider side. A further object of the invention is to permit the leveling of the loads of a system, more economical views for users, and the pursuit of the profit of an enterpriser.

The invention has for its object to raise a price which is presented to a view desiring person, in a case where the number of simultaneous view desiring persons seems to exceed the maximum load capacity of a video-on-demand system apparatus, whereby the number of users is controlled so as to fall within the maximum load capacity of the video-on-demand system apparatus, and the users can view a video without the degradation of an image quality. Besides, the invention has for its object to present substitute time zones and prices to view desiring persons, in a case where the number of simultaneous view desiring persons seems to exceed the maximum load capacity of a video-on-demand system apparatus, whereby the number of users is controlled so as to fall within the maximum load capacity of the video-on-demand system apparatus, and the users can view a video without the degradation of an image quality.

In order to accomplish the objects, it is a feature of the present invention that, by way of example, the plurality of program televising time zones of an identical program are presented to a user beforehand, whereupon the user registers his/her view desiring time zone beforehand, whereby the loads of a system are leveled, and the degradation of a video quality is made difficult to occur. Besides, a price is altered in accordance with the number of simultaneously viewing persons, and the profit of a service enterpriser is pursued. Another feature is that, in addition to the above means, a price which is altered in accordance with the number of simultaneously viewing persons, and the number of view desiring users are presented to the users, whereby the number of users in the program televising time zone can be controlled on an economy principle.

Another feature is that, in addition to the above means, the price which is presented to the viewer is kept by altering that threshold value of the number of viewers with which the price is changed in accordance with the number of simultaneous viewers, in a case where the increase of the number of view desiring persons within a unit time exceeds a predetermined value, whereby the number of users is controlled so as to fall within the maximum load capacity of a video-on-demand system apparatus, on the economy principle even in a case where the congestion of the simultaneous view desiring persons is anticipated.

Besides, in addition to the above means, the price which is presented to the view desiring persons may well be raised in a case where the number of the simultaneous view desiring persons seems to exceed the maximum load capacity of the video-on-demand system apparatus, whereby the number of users is controlled so as to fall within the maximum load capacity of the video-on-demand system apparatus, on the economy principle.

On the other hand, a substitute time zone and a substitute price may well be presented and recommended to view desiring persons in a case where the number of the simultaneous view desiring persons seems to exceed the maximum load capacity of a video-on-demand system apparatus, whereby the number of the view desiring persons is controlled so as to fall within the maximum load capacity of the video-on-demand system apparatus.

It is another feature that, in addition to the above means, a user is permitted to view a video by a user terminal which is different from a user terminal that the user uses for the registration of a view desire, whereby the convenience of the user is enhanced.

It is still another feature that, in addition to the above means, a portable telephone is set as a user terminal which a user uses for the registration of his/her view desire, whereby the convenience of the user is enhanced in such a manner that the user can register the use even from a visit place.

It is yet another feature that, in a case where a video or the like is multicast simultaneously to a plurality of users at 1:n (n being an integer of at least 2), desires are registered beforehand so that the users as many as possible may simultaneously view the video or the like, thereby to perform the guide or the like of the users on the economy principle.

It is a further feature that, in a video-on-demand scheme, the numbers of view desiring persons are totalized for a plurality of programs within an identical time zone, whereby the number of users is controlled so that the result of the totalization may fall within the maximum load capacity of a video-on-demand system apparatus.

According to the solving means of this invention, there is provided a video-on-demand system which accepts a view application of a content from terminals and which delivers the content to the terminals, comprising:

a delivery information storage area in which a content identifier, a plurality of view times for the content, and a plurality of prices corresponding to the number of view applications for each content identifier and each view time are stored beforehand; and

an application management function portion which evaluates the price of the content on the basis of the number of view applications from the terminals,

wherein said application management function portion:

receives view application information items each of which contains the content identifier of the content desired to be viewed, and the view time desired to be viewed, from a plurality of the terminals;

totalizes the view application information items from the plurality of terminals, thereby to evaluate the number of view applications for each content identifier and each view time;

refers to said delivery information storage area on the basis of the content identifier and the view time, so as to obtain the price conforming to the number of view applications among the plurality of prices which correspond to the content identifier and the view time;

transmits the content identifier in said delivery information storage area, the plurality of view times for the content, and the obtained price of the content identifier and each view time, to the terminal or another terminal; and

receives an alteration request from the terminal or the view application information from the other terminal.

According to the present invention, the profit of an enterpriser is enlarged by increasing the number of users of a video-on-demand system, and the degradation of a quality attributed to the excess of the capability of the system is preventable.

Besides, according to the invention, a plurality of program televising time zones are presented to a user beforehand, and the user registers his/her view desiring televising time zone beforehand from among the presented candidate time zones, whereby users can be distributed, and the loads of the system can be leveled.

According to the invention, a price which is altered in accordance with the number of simultaneous viewing persons, and the number of view desiring users are presented to a user, whereby the user can change into an economically advantageous televising time zone, and the numbers of users in the program televising time zones can be controlled by the price settings of a provider side. Accordingly, there are the advantages that the loads of a system can be leveled, and that more economical views are permitted for the users.

According to the invention, in addition to the above advantages, the price which is presented to a view desiring person is raised in a case where the number of simultaneous view desiring persons seems to exceed the maximum load capacity of a video-on-demand system apparatus, whereby the number of simultaneous view desiring persons can be controlled so as to fall within the maximum load capacity of the video-on-demand system apparatus, and the user can view a video without the degradation of an image quality. Besides, according to the invention, a substitute time zone and a substitute price are presented to a view desiring person in a case where the number of simultaneous view desiring persons seems to exceed the maximum load capacity of a video-on-demand system apparatus, whereby the number of simultaneous view desiring persons can be controlled so as to fall within the maximum load capacity of the video-on-demand system apparatus, and the user can view a video without the degradation of an image quality.

### BRIEF DESCRIPTION OF THE DRAWINGS

FIG. 1 is a block diagram of a system in an embodiment of the present invention;

FIG. 2 is a flow chart of an application management unit;

FIG. 3 shows an example of a sequence from the registration of the desire of a view to the start of the view;

FIG. 4 shows an example of the sequences of a content registration and a delivery information registration;

FIG. 5 shows an example of a content delivery information table;

FIG. 6 shows an example of a user screen display;

FIG. 7 shows an example of the relationship between the number of users and an income;

FIG. 8 shows the purchase probability curve of each price;

FIG. 9 shows the relationship between the number of users and an income according to the embodiment of the invention;

FIG. 10 is a block diagram of a system configuration in the second embodiment of the invention;

FIG. 11 shows a flow chart in the second embodiment;

FIG. 12 shows a content delivery information table in the second embodiment;

FIG. 13 is a flow chart in the third embodiment;

FIG. 14 is a block diagram showing the fourth embodiment;

FIG. 15 shows a user information table in the fourth embodiment;

FIG. 16 is a sequence diagram showing a procedure for associating a plurality of user terminals with a user (4) in a user database (106);

FIG. 17 is a sequence diagram showing a procedure from the registration of the desire of a view to the start of the view;

FIG. 18 shows an example of a totalization information table; and

FIG. 19 shows an example of a user view table.

### DESCRIPTION OF THE PREFERRED EMBODIMENTS

### 1. First Embodiment

Now, this embodiment will be described with reference to the drawings.

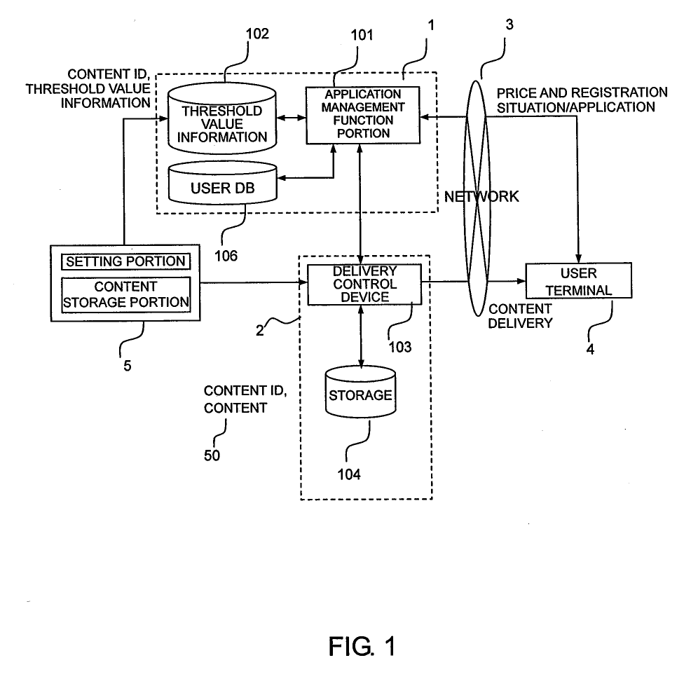

FIG. 1 is a block arrangement diagram showing an embodiment of a system (video-on-demand system) which realizes a video-on-demand scheme of joint purchase type.

The system includes, for example, an application management unit (application management device) 1 and a delivery control unit 2. The application management unit 1 and the delivery control unit 2 communicate with a user terminal 4 through a network 3. Incidentally, the system may well further include a content provision unit 5 in which contents are stored. The content provision unit 5 may well have, for example, a content storage portion such as a medium containing the contents (a record medium, for example, film or memory), and a setting portion for setting information items on the provision of the content, such as a delivery date and hour and a price.

The application management unit 1 has an application management function portion 101, a database 102 in which threshold value information, etc. concerning the delivery of the content are stored, and a user database (user DB) 106. The delivery control unit 2 has a delivery control device 103 and a storage 104. The application management unit 1 and the delivery control unit 2 are connected with the user terminal 4 through the network 3. The content 50 to be delivered is stored in the storage 104 of the delivery control unit 2 beforehand. Besides, information items such as the delivery date and hour, the price, and the price to the number of viewers (the threshold value information) which concern the delivery of the content 50 to-be-delivered are stored in the database 102. These information items are associated between the application management unit 1 and the delivery control unit 2 by identification signs (IDs) peculiar to the contents. Incidentally, the application management unit 1 and the delivery control unit 2 may be configured of one device, or they may well be the separate devices.

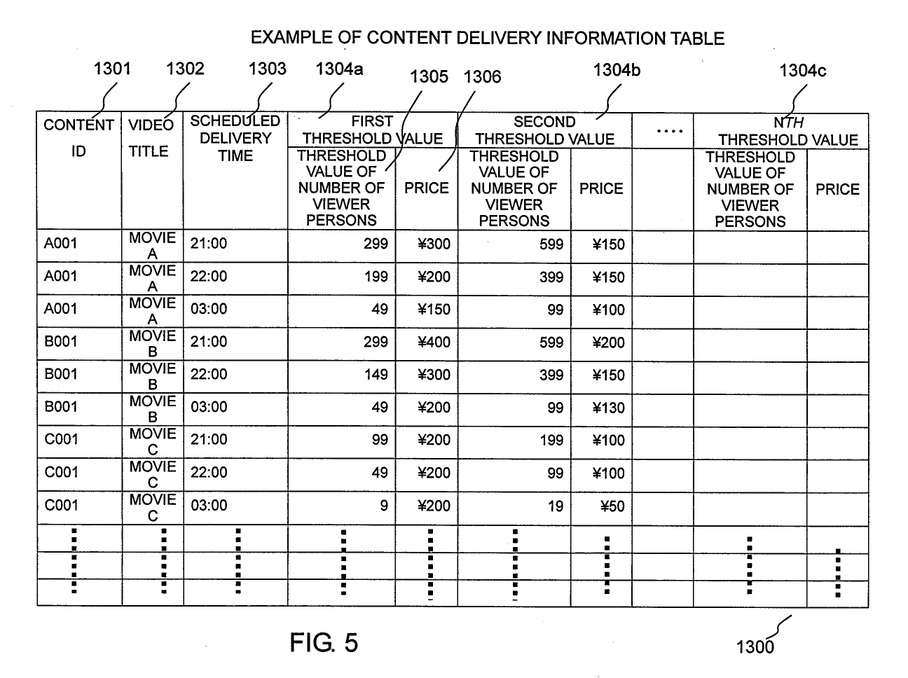

FIG. 5 shows an example of a content delivery information table.

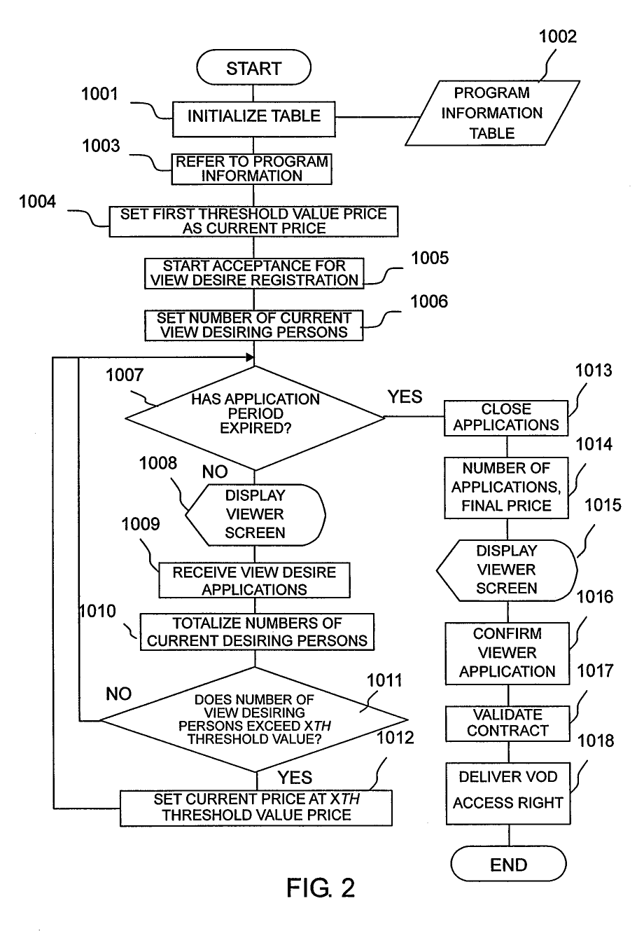

This table is stored in the database 102 in FIG. 1, and it corresponds to, for example, a program information table 1002 on a memory in the flow chart of FIG. 2 to be stated later.

In the content delivery information table (delivery information storage area) 1300, an identification sign (content ID) 1301 peculiar to a content, the title 1302 of the content, the scheduled delivery time (view time) 1303 thereof, first threshold value information 1304a, second threshold value information 1304b, subsequent threshold value information, and Nth threshold value information 1304c being a final threshold value, which are afforded when the content provision unit 5 has registered the content into the delivery control unit 2, are stored in correspondence. Besides, each threshold value information contains the threshold value 1305 of the number of viewer persons shifting to the next threshold value, and a price 1306 within the pertinent threshold value.

By way of example, the content delivery information table 1300 contains the first to Nth threshold values (N being an integer) of the number of view applications, a first price in the case where the number of view applications is equal to or smaller than the first threshold value, and an (i+1)th price in the case where the number of view applications is larger than an ith threshold value (i being an integer of any of 1 to (N−1)) and is equal to or smaller than an (i+1) th threshold value, every content ID 1301 and view time 1303. By way of example, for a content ID of “A001” and a scheduled delivery time of “21:00”, the prices are previously set in such a manner that the price is 300 yen (the first price) when the number of viewer persons is up to 299 (the first threshold value), and that it is 150 yen (the second price) when the number of viewer persons is from 300 to 599 (the second threshold value). By the way, in a case where the number of view applications has exceeded the Nth threshold value, any view application may be rejected, or an (N+1) th price in the case where the Nth threshold value has been exceeded may well be stored.

Each content is managed by the identification sign (ID) 1301 peculiar to the content, and matching is established between the application management unit 1 and the delivery control unit 2. A plurality of scheduled delivery times 1303 can be registered for each content. Besides, a plurality of threshold value information items 1304 can be registered for each of the scheduled delivery times, and the price 1305 and the threshold value 1306 of the number of viewer persons can be registered for each threshold value information.

Besides, in this example, the identical content is managed by one identification sign (ID) 1301 peculiar to the content, without regard to delivery times, but a plurality of identification signs (IDs) 1301 peculiar to the content may well be allotted to the identical content, depending upon the delivery times. In this case, there is considered the merit that, in a case where the program information table 1002 is to be updated, the update of only a pertinent time zone can be realized with ease.

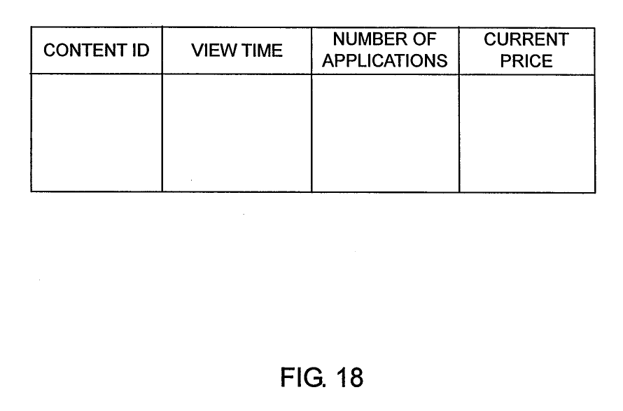

FIG. 18 shows a format example of a totalization information table.

In the totalization information table (totalization information storage area), the number of totalized applicant persons (the number of view applications) and a current price are stored in correspondence with, for example, an identification sign (content ID) peculiar to a content and the view time of the content.

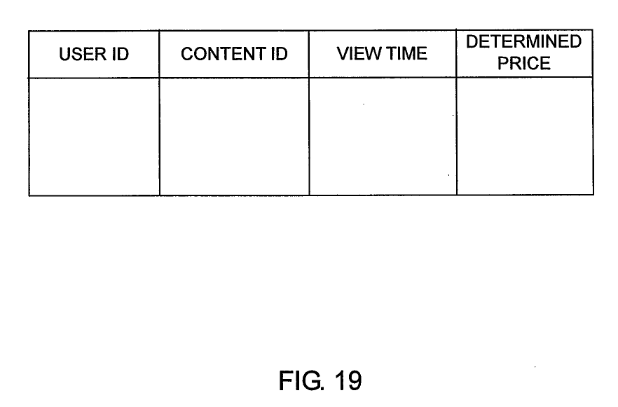

FIG. 19 shows a format example of a user view table.

In the user view table, the ID of a content desired to be viewed, a view time, and a determined price finally determined are stored in correspondence with, for example, a user ID. The totalization information table and the user view table are stored in, for example, the user database 106.

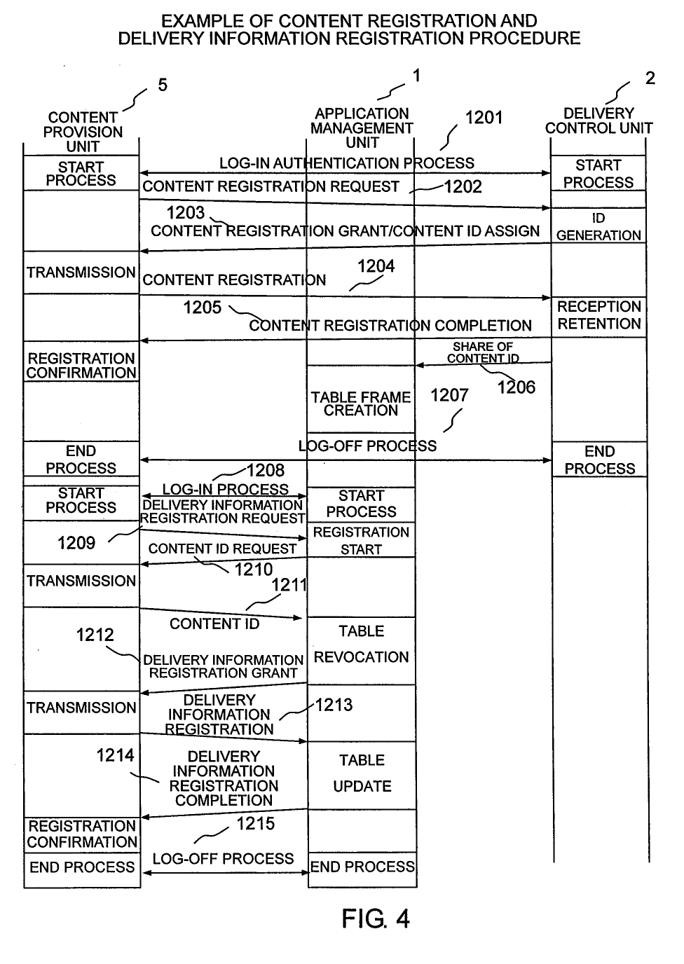

FIG. 4 is a sequence diagram of a content registration and a delivery information registration.

First, a user authentication is performed between the content provision unit 5 and the delivery control unit 2 by a log-in authentication process 1201. In a case where the authenticated content provision unit 5 is to register a content into the delivery system, this content provision unit 5 transmits a content registration request 1202 to the delivery control unit 2. When the delivery control unit 2 has received the content registration request 1202, it generates an identification sign (ID) peculiar to the content, and it notifies a content registration grant and the generated identification sign (ID) peculiar to the content, to the content provision unit 5 by a process 1203. Incidentally, apart from being generated by the delivery control unit 2, the content ID may be a predetermined one, or it may well be generated by the application management unit 1 or the like at any appropriate timing. The content provision unit 5 registers content data and relevant information which correspond to the identification sign (ID) peculiar to the content, into the delivery control unit 2 by a process 1204.

In the delivery control unit 2, the pertinent content etc. are received, the content data are retained in correspondence with the content ID, and a content registration completion notice 1205 is transmitted to the content provision unit 5. Besides, a content ID share information 1206 is transmitted from the delivery control unit 2 to the application management unit 1, and the identification sign (ID) peculiar to the registered content is shared between the delivery control unit 2 and the application management unit 1. In the application management unit 1, there is created the frame (area) of a table in which the identification sign (ID) peculiar to the content is stored and in which program delivery information corresponding to the ID is registered.

Owing to the processing thus far described, the content provision unit 5 completes the registration of the pertinent content into the delivery control unit 2. After the completion of the registration, the connection between the content provision unit 5 and the delivery control unit 2 is cut off by a log-off process 1207.

The information on the delivery of the content is retained in the application management unit 1 separately from the content body. In order to register the information on the delivery of the content, the content provision unit 5 first performs its connection with the application control unit 1, by a log-in process 1208. After the completion of the connection, the content provision unit 5 transmits a delivery information registration request 1209 to the application management unit 1. In the application management unit 1, a process for registering the delivery information of the content is started, and a content ID request 1210 is transmitted to the content provision unit 5 in order to confirm which content the information to be registered concerns. The content provision unit 5 transmits the identification sign (ID) peculiar to the content, 1211 as afforded when the pertinent content was registered into the delivery control unit 2, to the application management unit 1. In the application management unit 1, the table frame (area) corresponding to the identification sign (ID) peculiar to the pertinent content is invoked, and a delivery information registration grant 1212 is transmitted to the content provision unit 5.

The content provision unit 5 receives the delivery information registration grant 1212, and it transmits a delivery information registration 1213 corresponding to the pertinent ID, to the application management unit 1. By way of example, the content ID, video title, scheduled delivery time, and first to Nth threshold value information items are transmitted. In the application management unit 1, the table is updated on the basis of the received information items. By way of example, the received data are stored in the content delivery information table 1300 of the database 102. The application management unit 1 notifies a delivery information registration completion 1214 to the content provision unit 5, and the registration of the program delivery information is completed. When all the processes have ended, the connection between the content provision unit 5 and the application management unit 1 is cut off by a log-off process 1215.

FIG. 2 is a flow chart concerning the operation of the application management unit 1.

After the start of the operation, the application management unit 1 (for example, the application management function portion 101, and the same holds true below) initializes the program information table 1002 on the memory, by table initialization 1001. Subsequently, information items relevant to a program, within the database 102 are referred to by a step 1003. By way of example, the information items of the content delivery information table 1300 in FIG. 5 are loaded into the memory (program information table)

Incidentally, the program information table can have a format similar to that of the content delivery information table 1300. The application management device 101 sets a first threshold value price 1206 in the program information table 1002, as a current price by a step 1004. By way of example, the first threshold value prices 1206 are stored as the current prices of the totalization information table as to the respective content IDs and view times. Subsequently, registration acceptances for view desires are started on the basis of the program information table 1002 by a step 1005. At a step 1006, the application management device 101 initializes the number of current view desiring persons and the number of view desiring persons to the next threshold value. At a step 1007, the application management device 101 decides the expiration of a predetermined application period which is stored in, for example, the program information table 1002. Within the application period (“No”), the routine proceeds to a step 1008, and in a case where the application period has expired (“Yes”), the routine proceeds to a step 1013.

The step 1008 is a step at which the application management device 101 displays the number of the current view desiring persons, the current price, and the number of the view desiring persons to the next threshold value price as have been computed at, for example, the steps 1004, 1006, etc., on the user terminal 4. Actual displays are presented as the result of communications through the network 3.

The user applies for his/her view desire at a step 1009 by reference to that view application situation of the content which is displayed on the user terminal 4. The results of view desire applications from a plurality of user terminals 4 are totalized by a step 1010. At a step 1011, the application management device 101 judges if the number of the view desire applications totalized by the step 1010 has exceeded the Xth (X being any integer of 1 to N) threshold value within the program information table 1002. By way of example, the current j th price (j being any integer of 1 to N) is evaluated from the number of the current view desiring persons, and the number of the view desiring persons to the number of the next (j+1)th threshold value persons is computed, whereupon the routine returns to the step 1006. By way of example, it is obtained that the evaluated number of view applications lies between the (j−1)th threshold value and the j th threshold value, and the corresponding jth price is obtained. Besides, the number of applications required for the price to become the (j+1)th one is obtained by taking the difference between the number of view applications and the (j+1)th threshold value.

Further, in the case where the application period has expired, the application management device 101 closes the applications by the step 1013. At a step 1014, the application management device 101 totalizes the numbers of final applications on the basis of the results of the closed applications, and it determines a final price from the program information table 1002 on the basis of the totalized number. The application management device 101 transmits the determined result to the user terminal 4 through the network 3 by a step 1015. The user confirms the final application by a step 1016 on the basis of the result displayed on the user terminal 4. After the application confirmation, the user validates a contract by a step 1017. The application management device 101 transmits validated contract contents to the program delivery control unit 2 as video-on-demand access right information by a step 1018. Owing to the processing thus far described, the user can obtain the right of viewing his/her desired program in his/her desired time zone.

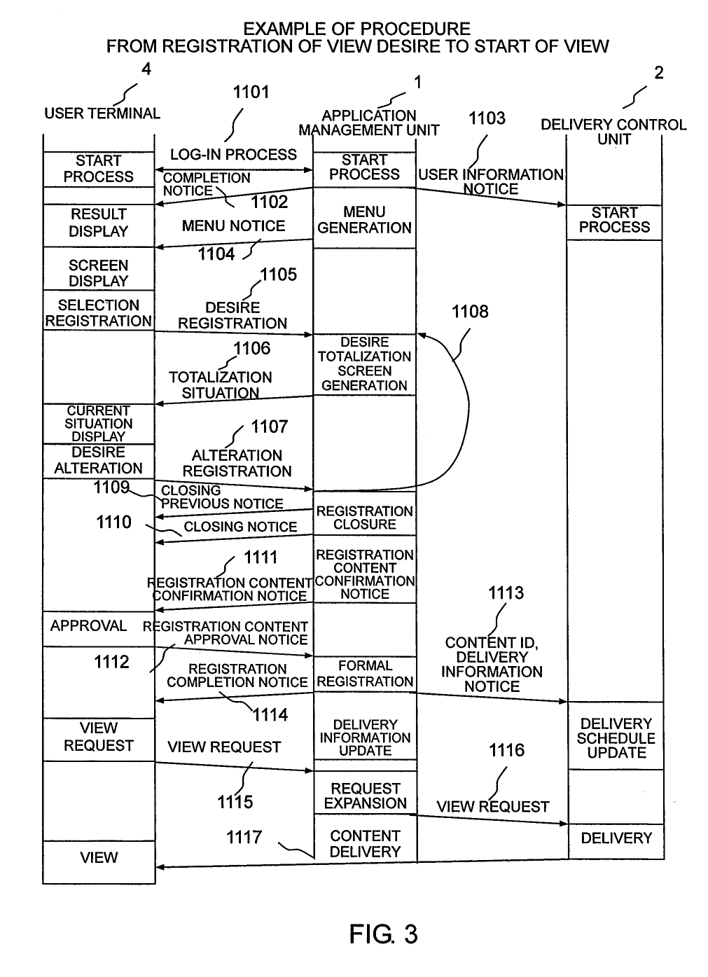

FIG. 3 shows an example of a sequence from the registration of a view desire to the start of a view.

Next, the operation of the application management unit 1 will be described in conjunction with the sequence diagram of FIG. 3. A log-in process 1101 is a process for confirming if the user terminal 4 is a legal user, between the application management unit 1 and the user terminal 4. In this process, information items, for example, a number peculiar to the user terminal 4 and a password are collated with system registration information items. When this process ends, a log-in completion notice 1102 is sent from the application management unit 1 to the user terminal 4. Besides, the application management unit 1 sends out a user information notice 1103 to the delivery control unit 2. The user information notice 1103 can contain, for example, a user ID, a terminal ID and a terminal type. In the delivery control unit 2, a start process for delivery is executed on the basis of the user information notice 1103.

When the user terminal 4 receives the completion notice 1102, it displays, for example, a log-in result. When the log-in result is normal, the procedure proceeds to the next process, whereas when the log-in result is not normal, the log-in process is executed again.

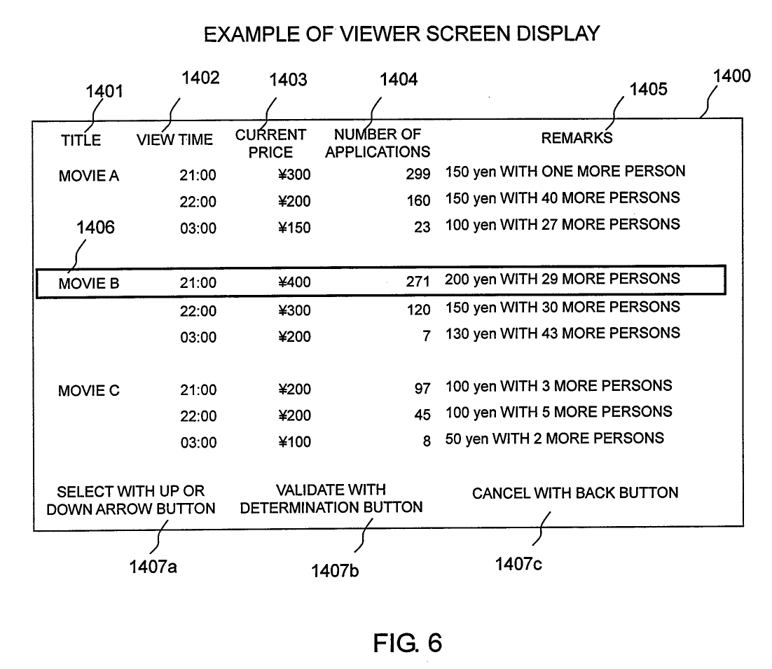

For the user who has normally logged in, the application management unit 1 transmits a menu which this application management unit 1 has generated on the basis of the program information table 1002 on the memory or the content delivery information table on the database 102, to the user terminal 4 by a menu notice 1104. The menu which is transmitted contains, for example, a content ID, a video title and a scheduled delivery time (view time). Further, the menu may well contain a current price, the number of current applications, etc. In the user terminal 4, the menu is displayed on the screen. By way of example, a screen example (to be stated in detail later) shown in FIG. 6 can be displayed. Incidentally, a current price, the number of applications and a remarks column may well be omitted here. When the user selects a view desire and executes a registration manipulation, a desire registration (view application) 1105 is transmitted from the user terminal 4 to the application management unit 1. The desire registration contains, for example, the user ID, the ID of the selected content, and the view time.

The application management unit 1 receives the desire registration, and it stores the content ID and the view time in the user view table of the user database 106 in correspondence with the user ID. Besides, the application management unit 1 receives desire registrations 1105 from the plurality of user terminals 4, and it totalizes them so as to generate a desire totalization screen. By way of example, the application management unit 1 evaluates the number of applications for each content specified by the content ID and the view time, and it evaluates the current price in comparison with threshold value information stored in the content delivery information table. Besides, the application management unit 1 stores the number of applications and the current price as have been evaluated, in the totalization information table in correspondence with the content ID and the view time. Further, it is also allowed to evaluate the number of persons to the next threshold value at which the price is altered by the increase of the number of applications. As the desire totalization screen, the application management unit 1 transmits to the user terminal 4, totalization information 1106 containing the video title, the view time, the current price and application number of each video and view time, and the number of persons to the next threshold value at which the price is altered by the increase of the number of applications, and the user terminal 4 displays the totalization information 1106 (FIG. 6).

The user can perform a registration for moving to a more advantageous delivery time zone, on the basis of the current application situation displayed on the user terminal 4. In a case where any alteration from the content and view time registered by the desire registration 1105 is desired, the user transmits an alteration registration (alteration request) 1107 from the user terminal 4 to the application management unit 1. In the application management unit 1, when the registration is not closed yet, the procedure returns to the desire totalization step by a sequence 1108, and the current registration situations are totalized so as to generate a screen. Until a registration closing time, the steps of the totalization information 1106 to the sequence 1108 are repeated.

Besides, at a stage at which the closing time has come near, the application management unit 1 sends a closing previous notice 1109 to the user terminal 4, and it is notified to the user that the closing time is near. When the closing time has been reached, the application management unit 1 sends a closing notice 1110 to the user terminal 4, thereby to notify an application closure to the user. Thereafter, any application input to the pertinent content is intercepted.

In the application management unit 1, final registration contents are confirmed when the application has been closed. By way of example, the price is determined on the basis of that number of the final applicants which is stored in the totalization information table. Besides, the determined price may well be stored in the user view table in correspondence with the pertinent content identifier and view time. A registration content confirmation notice 1111 is transmitted to the user terminal 4 subjected to the view desire registration. The user confirms the registration contents displayed on the user terminal 4, and he/she transmits a registration content approval notice 1112 to the application management unit 1 in a case where any error is not contained in the registration contents.

The application management unit 1 having received the registration content approval notice 1112 registers application information formally, and it sends the identification sign (ID) peculiar to the content, and delivery information 1113, to the delivery control unit 2. By way of example, the application management unit 1 sends the content identifier and the corresponding user ID and view time as are stored in the user database 106, to the delivery control unit 2. In the delivery control unit 2, a delivery schedule is updated on the basis of the received information items.

Besides, the application management unit 1 sends a registration completion notice 1114 to the user terminal 4 after the completion of the formal registration of the application information. Owing to the registration completion notice 1114, the registration for the program view is completed.

The user terminal 4 can view the program at the view time registered by the user. In viewing the program, a view request 1115 is transmitted from the user terminal 4 to the application management unit 1. After accepting the view request 1115, the application management unit 1 transfers a view request 1116 to the delivery control unit 2. The delivery control unit 2 starts the delivery of the program on the basis of the transferred view request, and the content 1117 is delivered to the user terminal 4. Incidentally, the content may well be delivered by multicast communications of 1:n.

FIG. 6 shows an example of a screen which is displayed on the user terminal 4.

The screen as shown in FIG. 6 can be displayed on the display 1400 of the user terminal 4 after the user has completed the log-in manipulation. In a title column 1401, the titles of viewable contents are indicated. One or more viewable times 1402 are indicated for each of the contents. Besides, a current price 1403 and the number of applications, 1404 are indicated every viewable time. The numbers of applicants who are required to threshold values for shifting to next price zones, these numbers being computed in accordance with the contents of the program information table 1002 in FIG. 2 (or the content delivery information table in FIG. 5), are indicated in a remarks column 1405. The user selects a view desire by utilizing an input device, for example, a remote controller. On this occasion, a selected part may well be displayed so as to clearly differ from any other choice on the screen, owing to highlighting 1406. At the lower part of the screen, easy ways of uses can be indicated as at 1407a to 1407c.

The user can easily select his/her desired program and the view time thereof on the basis of the contents displayed on the user terminal 4. Moreover, since the current prices and the numbers of the required persons to the next prices are also displayed, the user is permitted to economically view the content which he/she desires.

Next, it will be indicated that, even in a case where content provision prices have been lowered to distribute users, the maximization of an income or the pursuit of a profit is expected.

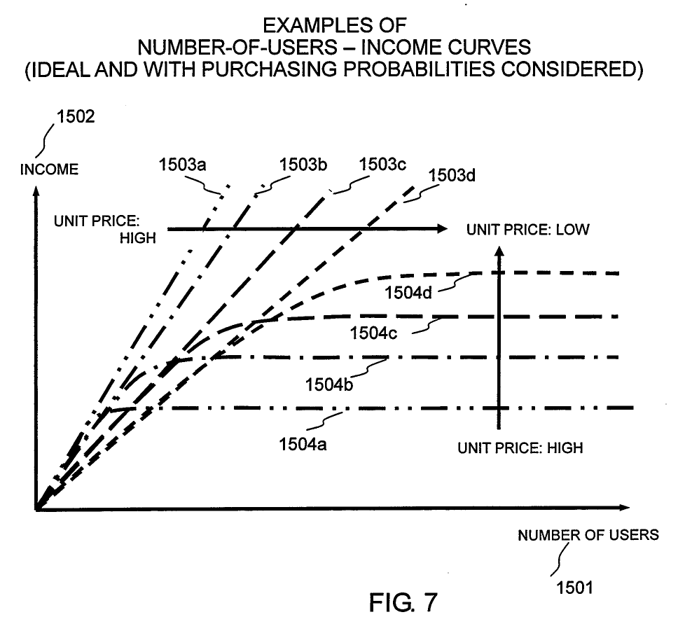

FIG. 7 shows an example of the relationship between the number of users and an income.

The number of users, 1501 is taken on the axis of abscissas, while the income of an enterpriser, 1502 is taken on the axis of ordinates. Straight lines 1503a to 1503d indicate ideal income straight lines. In this example, a unit price is the highest in the straight line 1503a, and it is the lowest in the straight line 1503d. Therefore, the number of users necessary for obtaining the same income is the smallest in the straight line 1503a of the maximum unit price, and it is the largest in the straight line 1503d of the minimum unit price. In order to enlarge the income, accordingly, raising the unit price is thought to be the best method, but in actuality, the purchasing will of the user as differs every unit price needs to be considered.

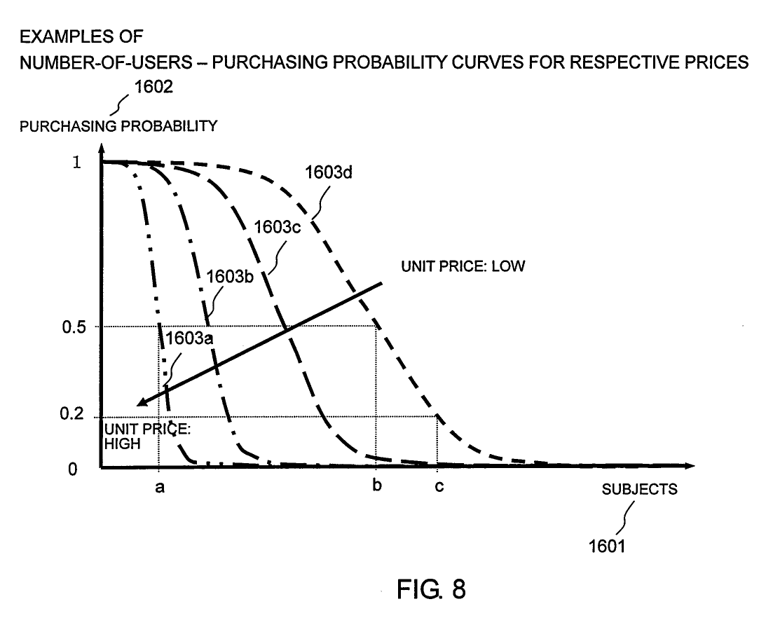

FIG. 8 shows an example of a graph in which the number of users and a purchasing probability, namely, the purchasing will are indicated every price.

The number of subjects, 1601 is taken on the axis of abscissas, while the purchasing probability 1602 is taken on the axis of ordinates. Curves 1603a to 1603d are curves which indicate the purchasing probabilities of the respective prices. The curve 1603a corresponds to a case where a unit price is the highest, and the curve 1603d corresponds to a case where the unit price is the lowest. The curve 1603d, for example, indicates that there are b persons whose purchasing probabilities are 0.5. This indicates that, among the b persons, 50% will purchase a content, whereas the remainder will not purchase the content. Besides, the curve 1603d indicates that there are c persons whose purchasing probabilities are 0.2. This indicates that, among the c persons, 20% will purchase the content, whereas the remainder will not purchase the content. On the other hand, the curve 1603a of higher unit price indicates that only a persons who are smaller in number than the b and c persons exist as the persons whose purchasing probabilities are 0.5.

The individual curves have normal distributions in this example. In the curve 1603a of the highest unit price, the purchasing probability decreases suddenly at a stage at which the number of users is small, and it becomes zero in due course. This indicates that the number of persons who purchase the content at the high unit price is small. The tendency becomes gentler as a shift from the curve 1603b to the curve 1603d, and it is indicated that the increase of purchasers is anticipated in a case where the unit price is lowered.

In case of studying the number of users and the income expectation in FIG. 7, the number of users and the purchasing probability of each unit price as shown in FIG. 8 need to be considered. A curve 1504a in FIG. 7 indicates a more actual income expectation by multiplying the straight line 1503a by the probability curve 1603a in FIG. 8. Likewise, each curve 1504 is indicated by multiplying the curve 1503 and probability curve 1603 of each price. Incidentally, although the curve 1504 has been indicated on FIG. 7 for the sake of convenience in order to describe this embodiment, the axis of abscissas does not represent the simple number of users, but it represents a value in which the probability based on the purchasing price is considered, because of the multiplication by the probability curve 1603.

Regarding such curves 1504, the highest income can be expected of the curve 1504a of the highest unit price, in a range of a small number of users, but the income expectation is saturated because users exceeding a certain extent of number cannot be expected. With the curve 1504b the unit price of which is lower than that of the curve 1504a, the income is lower than with the curve 1504a, in a range of a small number of users. Since, however, the price is lowered, more users can be expected. Therefore, although the income expectation is finally saturated, the income at that time becomes higher than in the case of the curve 1504a of the highest unit price. Likewise, with the curves 1504c and 1504d, increases in the numbers of users can be respectively expected in correspondence with the lower components of the unit prices, and hence, the incomes enlarge.

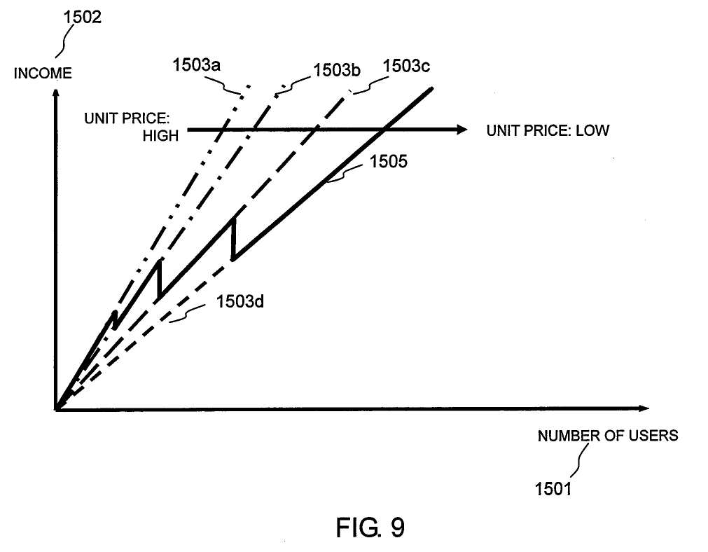

FIG. 9 shows the relationship between the number of users and an income expectation according to this embodiment.

The axis of abscissas represents the number of users, while the axis of ordinates represents the income expectation. A straight line 1503 indicates the ideal income expectation of each price. A curve 1505 indicates the income expectation in the case where the price has been altered depending upon the number of use desiring persons, according to this embodiment. In this embodiment, when a preset number of users are exceeded, a unit price is altered to a preset lower price on a system side. Therefore, the curve 1505 becomes a curve of saw-tooth shape. The income expectation lowers once, but a larger income is expected owing to the increase of the users based on a price decrease.

In this manner, according to this embodiment, the unit price is not simply lowered, but it can be lowered in accordance with the demand of the users, so that the maximization of the income can be attained meritoriously. Besides, according to this embodiment, the users shift into cheaper time zones on an economy principle, so that the overload of the delivery control unit or the like attributed to the concentration of loads can be avoided.

### 2. Second Embodiment

Now, the second embodiment will be described with reference to the drawings. In this embodiment, a number-of-viewer threshold value for altering a price is altered in a case, for example, where the number of view applicants within a unit time has exceeded a predetermined threshold value.

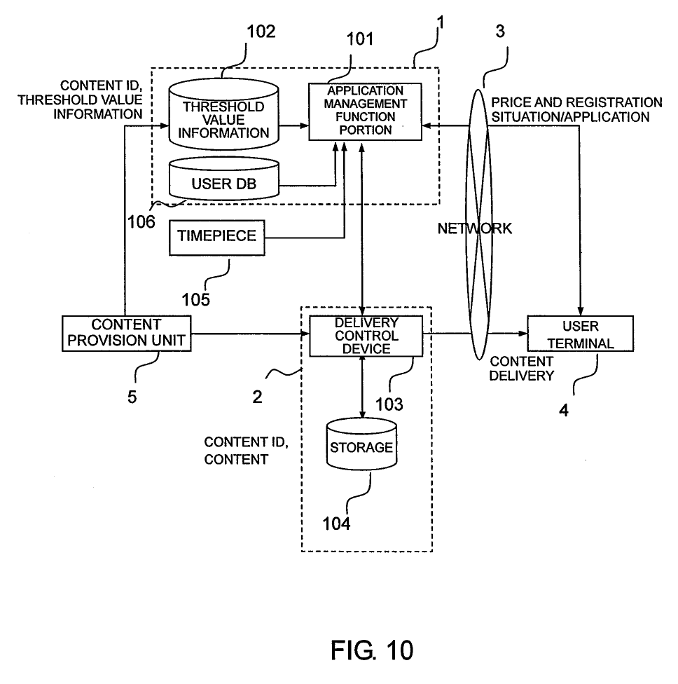

FIG. 10 is a block arrangement diagram of a system which realizes a video-on-demand scheme of joint purchase type in this embodiment. The configuration of the system further includes a timepiece 105 as compared with the block arrangement diagram shown in FIG. 1.

In this embodiment, the system includes an application management unit 1 and a delivery control unit 2. Besides, the system may well include a network 3, a user terminal 4 and a content 5. The application management unit 1 has an application management function 101, a database 102 in which threshold value information items on the delivery of the content are stored, and a user database 106. The delivery control unit 2 has a delivery control device 103, and a storage 104. Besides, the timepiece 105 is connected to the application management unit 1, and the predetermined unit time can be measured. Incidentally, the timepiece may well be installed inside the application management unit 1. The application management unit 1 and the delivery control unit 2 are connected to the user terminal 4 through the network 3. The content 5 to be delivered is stored in the storage 104 of the delivery control unit 2 beforehand. Also, information items such as the delivery date and hour, the price, and the price to the number of viewers, which concern the delivery of the content 5 to-be-delivered are stored in the database 102. These information items are associated between the application management unit 1 and the delivery control unit 2 by an identification sign (ID) peculiar to the content. Incidentally, the remaining configuration is the same as in the first embodiment.

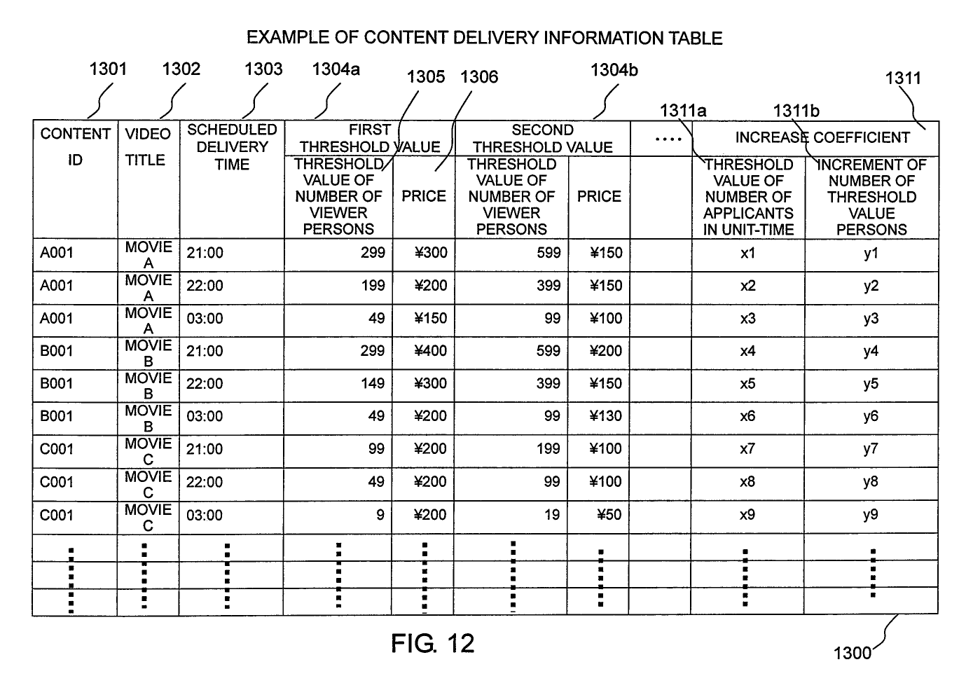

FIG. 12 shows a format example of a content delivery information table in this embodiment.

A program information table 1002 is similar. In this embodiment, the program information table 1002 further has increase coefficient information 1311 every content, in addition to the contents of the first embodiment. The increase coefficient 1311 contains the threshold value 1311a of the increment of the number of unit-time applicants, and the increment 1311b of the number of threshold-value persons.

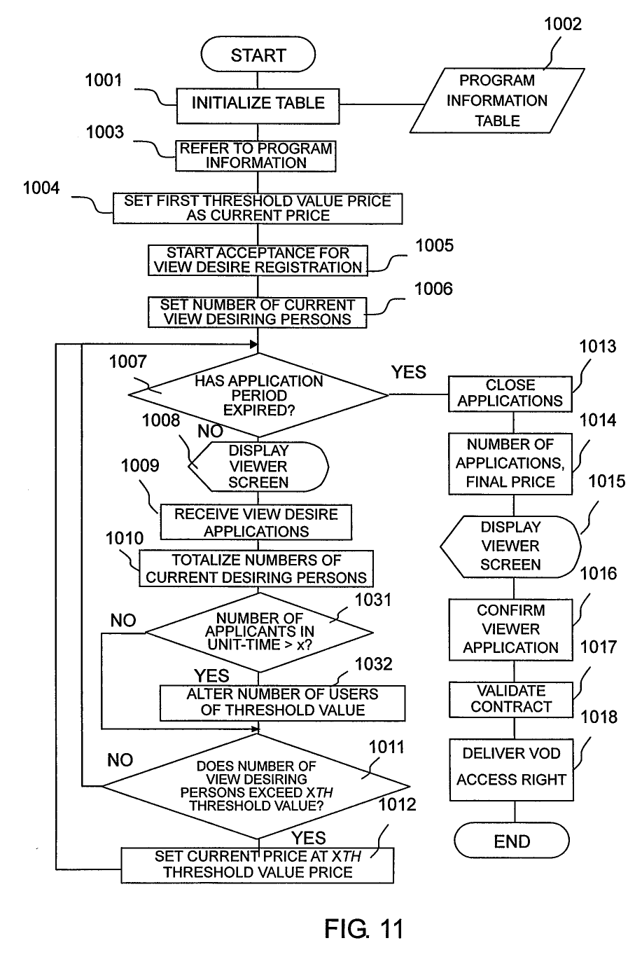

FIG. 11 shows an example of a flow chart in the second embodiment.

The operation of the application management unit 1 will be described in conjunction with the flow chart shown in FIG. 11. This flow chart is such that the flow chart shown in FIG. 2 has been partly altered. Since the same numerals as in FIG. 2 indicate the same steps as in the first embodiment, they shall be omitted from detailed description.

After the start of the operation, the application management unit 1 initializes the program information table 1002 by table initialization 1001. Subsequently, information items relevant to a program, within the database 102 are referred to by a step 1003.

The application management device 101 sets a first threshold value price in the program information table 1002, as a current price by a step 1004. Subsequently, registration acceptances for view desires are started on the basis of the program information table 1002 by a step 1005. At a step 1006, the threshold value price of the program information table 1002 is referred to on the basis of the number of the current view desiring persons, and the numbers of view desiring persons to the jth price and the next (j+1)th threshold value price are computed from the number of the current view desiring persons. A step 1007 decides the expiration of an application period which is stipulated by the program information table 1002. Within the application period, the routine proceeds to a step 1008, and in a case where the application period has expired, the routine proceeds to a step 1013.

The step 1008 is a step at which the application management device 101 displays the number of the current view desiring persons, the current price, and the number of the view desiring persons to the next threshold value price as have been computed at the step 1006, on the user terminal 4. Actual displays are presented as the result of communications through the network 3. The user applies for his/her view desire at a step 1009 by reference to that view application situation of the content which is displayed on the user terminal 4. The results of view desire applications from a plurality of user terminals 4 are totalized by a step 1010.

In this embodiment shown in FIG. 11, unlike in the flow chart of FIG. 2, the application management unit 1 judges whether or not the increment of the number of the view desiring applicants within a unit time exceeds the value x of the threshold value 1311a of the increment of the number of unit-time applicants as is set in the program information table 1002 beforehand, at a step 1031 after the step 1010 by way of example. In a case where the number of the view desiring applicants within the unit time has exceeded the value x set by the increment 1311a of the number of unit-time persons, the threshold value 1305 of the number of the current viewing persons, within the program information table 1002 is increased the increment 1311b of the number of threshold value persons, at a step 1032. Owing to this manipulation, the congestion of users in such a case where the applications of the viewers rush can be controlled on the economy principle. It is possible to prevent, for example, the congestion ascribable to dashing applications immediately after the release of a newly created movie.

The subsequent steps are the same as in the example of FIG. 2 and shall be therefore omitted. Besides, the sequences are the same as the examples of FIGS. 3 and 4 and shall be therefore omitted.

According to this embodiment, the content which may possibly cause the congestion of the users is judged on the basis of the number of the applications within the unit time, and the initial threshold value of the number of the applicants is gradually increased, whereby the price is kept, and the congestion of the users can be avoided on the economy principle.

### 3. Third Embodiment

Now, the third embodiment will be described with reference to the drawings. In this embodiment, in a case where the number of the applications of users exceeds the system capability of the delivery control unit 2, an alternative measure is presented to a user, whereby the distribution of the users is promoted, and the excess of the system capability is avoided.

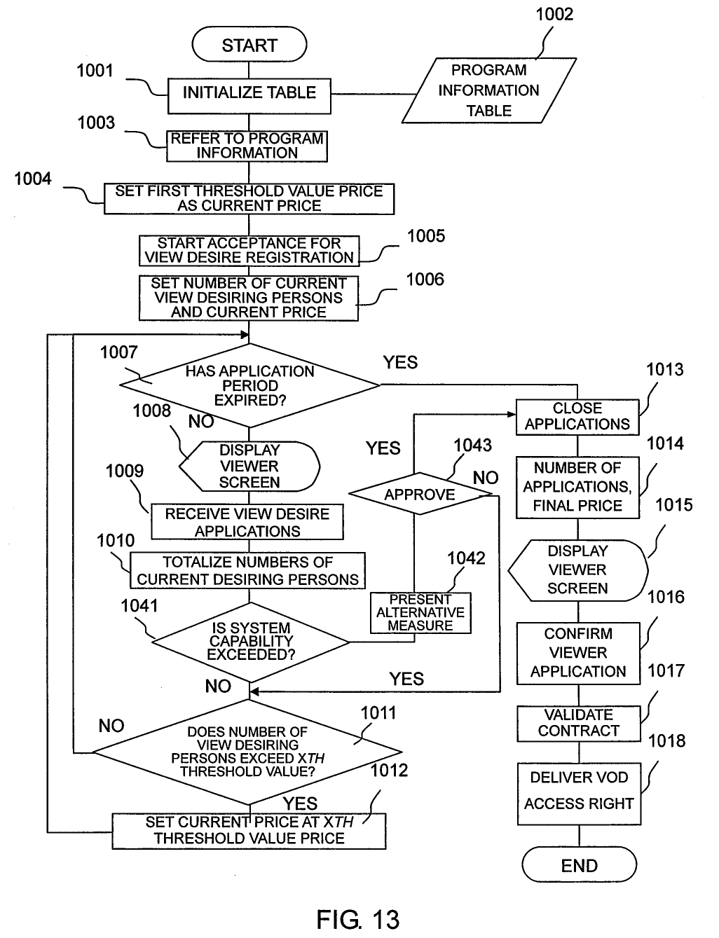

FIG. 13 shows an example of a flow chart for explaining the operation of this embodiment. Since the same numerals as in FIG. 2 indicate the same steps as in the first embodiment, they shall be omitted from detailed description. Incidentally, the general system configuration can be performed by the same configuration as shown in FIG. 1.

In FIG. 13, unlike in the first embodiment and the second embodiment, whether or not the number of the applications of users exceeds the system capability (predetermined threshold value) of the delivery control unit 2 is judged by a step 1041. The system capability being the criterion of the step 1041 depends upon the system, and it is a value which is basically independent of contents. Accordingly, the system capability can be previously set in the application management unit 1 as a value peculiar to, for example, the delivery control unit 2. Incidentally, it is one method of performance to store the set value in the program information table 1002.

The numbers of view desiring persons are totalized by the totalization 1010 of the numbers of view desiring persons, and the application management unit 1 compares the totalized number (total value) of the view desiring persons and the capability of the delivery control unit 2, at a step 1041. In a case where, as the result of the comparison, the total value does not exceed the capability of the delivery control unit 2, the routine proceeds to a step 1011, a price alteration is judged in the same manner as in the first embodiment, and the subsequent steps are carried out in accordance with the result of the judgment. On the other hand, in a case where, as the result of the comparison, the total value has exceeded the capability of the delivery control unit 2, the routine proceeds to the presentation 1042 of an alternative measure, and the application management unit 1 presents the alternative measure different from a currently desired measure, to the user terminal 4. The alternative measures for the respective contents can be previously stored in the program information table 1002 as one method, or they can also be prepared as a separate table. Besides, the application management function portion 101, for example, may well refer to the delivery information table 1300 on the basis of a content ID and a view time which are contained in view application information, so as to acquire another view time corresponding to the content ID. Subsequently, it may well obtain a price corresponding to the content identifier and the other view time, by referring to, for example, the totalization information table, and transmit alternative measure information containing the other view time and the price, to the terminal which has received a view application.

When the user approves the alternative measure presented by the presentation 1042 of the alternative measure, at alternative measure approval 1043, the routine shifts to application closure 1013 so that the alternative measure can be preferentially viewed. Besides, in a case where the user does not approve the alternative measure, the routine proceeds to the judgment 1011 of the threshold value of view desiring persons, and the desire of the initial content view is kept.

In this procedure, in a case where the user to whom the alternative measure has been presented does not approve the alternative measure, it is anticipated that the system capability of the delivery control unit 2 will be exceeded. As a method for avoiding the excess of the system capability, there is considered a method in which the value of the system capability of the delivery control unit 2 for use in the judgment 1041 is endowed with an allowance for the actual system capability of the delivery control unit 2, a method in which the presentation 1042 of the alternative measure is simultaneously done to a plurality of users, thereby to heighten the possibility of the existence of the user who will approve the alternative measure, or the like. A method in which such methods are combined is also considered. By the way, in the case of presenting the alternative measure to the plurality of users, the users to whom the alternative measure is presented may be selected by a method in which the alternative measure is presented from the last person in an application order, a method in which these users are extracted at random from among applicants, a method in which the users are let register the proprieties of the approvals of the alternative measure, at the times of applications, and in which the alternative measure is presented to the users having approved this alternative measure, or the like.

Besides, in a case where the view times of a plurality of contents overlap in a certain time zone, the application management function portion 101 may well totalize the numbers of the respective view applications for the plurality of contents, thereby to obtain the total number of the view applications in the time zone. When the total number of the view applications exceeds a predetermined threshold value, the portion 101 may well transmit the alternative measure information to the terminal having received the view application.

According to this embodiment, the system does not accept the number of users exceeding the system capability. Therefore, the user is permitted to use the system within the scope of the capability of the delivery control unit 1, so that he/she can view a video of high quality without suffering from the deterioration of the video.

Apart from this example, as a method for preventing the excess of users in the case where the number of the applications of the users exceeds the system capability of the delivery control unit 2, there is considered a method in which the applications are closed in adaptation to the system capability of the delivery control unit 2, a method in which a price is raised when the system capability of the delivery control unit 2 is exceeded, so as to decrease view desiring persons on the economy principle, or the like.

### 4. Fourth Embodiment

Now, the fourth embodiment will be described with reference to the drawings.

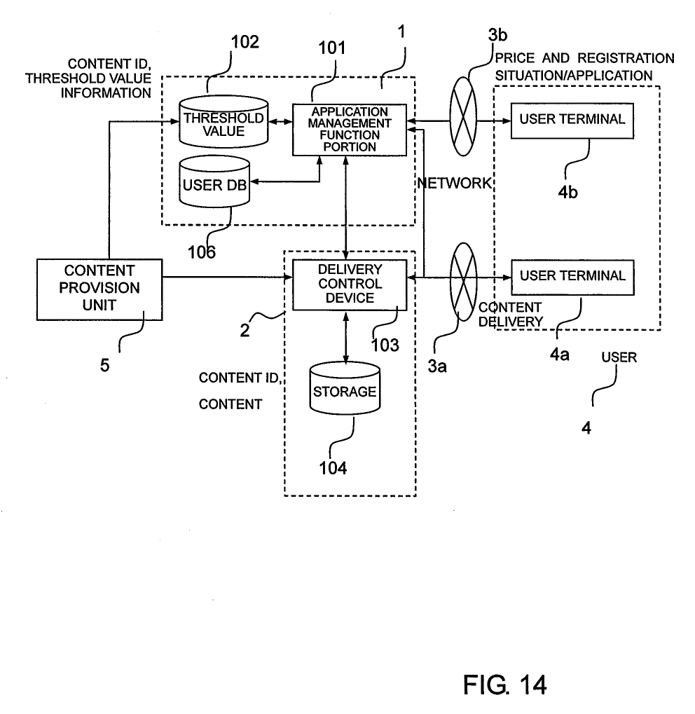

FIG. 14 is a block arrangement diagram of a system which realizes a video-on-demand scheme of joint purchase type in this embodiment. The system of this embodiment includes an application management unit 1 and a delivery control unit 2. Further, the system may well include networks 3, user terminals A 4a and B 4b, and a content 5. In this embodiment, however, the user terminal 4 in each of the above embodiments corresponds to the user terminal A 4a for viewing a video, and the user terminal B 4b for registering an application. Besides, the user terminals A 4a and B 4b are connected through the networks 3a and 3b, respectively. Incidentally, this embodiment can be combined with the first to third embodiments described before.

The application management unit 1 has an application management function 101, a database 102 in which threshold value information items concerning the delivery of the content are stored, and a user database 106 in which the terminal information items of users are stored. The user database 106 stores therein the information items for associating the user terminal A 4a and user terminal B 4b of each user.

The delivery control unit 2 has a delivery control device 103 and a storage 104. The application management unit 1 is connected with the user terminal B 4b through the network 3b. Besides, the delivery control unit 2 is connected with the user terminal A 4a through the network 3a. The content 5 to be delivered is stored in the storage 104 of the delivery control unit 2 beforehand. Besides, information items such as the delivery date and hour, the price, and the price to the number of viewers, which concern the delivery of the content 5 to-be-delivered, are stored in the database 102. These information items are associated between the application management unit 1 and the delivery control unit 2 by identification signs (IDs) peculiar to the contents.

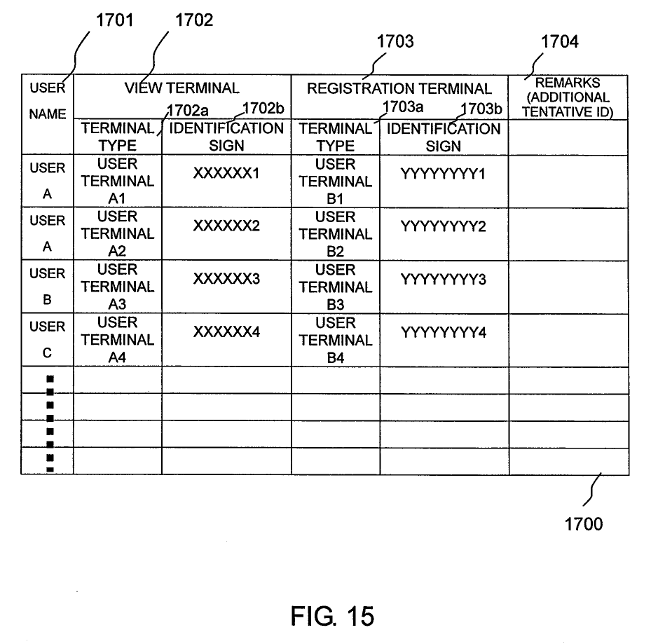

FIG. 15 shows a format example of a user information table 1700 within the user database 106.

The user information table 1700 contains the elements of a user name 1701, view terminal information 1702, registration terminal information 1703 and remarks 1704. The view terminal information 1702 further contains a terminal type 1702a and a terminal identification sign 1702b. Likewise, the registration terminal 1703 further contains a terminal type 1703a and a terminal identification sign 1703b. These elements are associated with the user name 1701 as a key.

Besides, a user can register a plurality of view terminals 1702 and registration terminals 1703. The example in FIG. 15 is an example in which the user A has registered two view terminals and two registration terminals. In this example, for the sake of convenience, it seems that the user terminal A1 being the view terminal, and the user terminal B1 being the registration terminal are associated, and that the user terminal A2 being the view terminal, and the user terminal B2 being the registration terminal are associated. However, all the view terminals 1702 and all the registration terminals 1703 belonging to the identical user are associated, and the user can perform the registration and the view from any terminals.

According to this embodiment, the user can apply for a view desire from the registration terminal which is different from the view terminal. Therefore, even in a case where the view terminal is viewing a program, the user can register the view desire. Besides, in a case where a portable telephone is used as the user terminal B 4b and where a portable telephone network is used as the network 3b, the user can register the program viewing desire even from a visit place or the like.

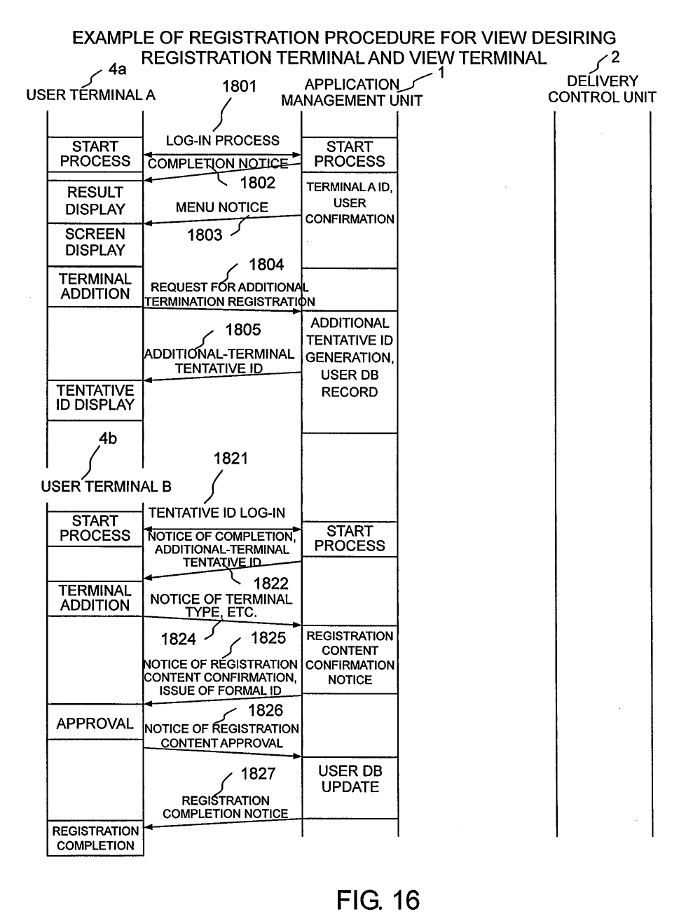

FIG. 16 is a sequence diagram showing a procedure for registering a plurality of user terminals into the user database 106 in this embodiment, in association with the user 4.

It is assumed that, in this example, the user terminal A 4a is registered as a terminal owned by the user 4, beforehand, so the user name (or user ID) 1701 and the view terminal information 1702 are registered in the user database 106. As a method for registering the user terminal A 4a, there is considered, for example, a registration based on a document or ID write at the sale of the terminal.

The addition of a new terminal is made by performing an additional registration from the user terminal A 4a already registered in the user database 106, into the application management unit 1. The procedure of this example will be indicated below.

First, log-in is made from the user terminal A 4a to the application management unit 1 by a log-in process 1801. The completion of the log-in is notified from the application management unit 1 to the user terminal A 4a by a completion notice 1802. The application management unit 1 collates the terminal identification sign, the user name, etc. transmitted from the user terminal A 4a at the time of the log-in, with the contents of the user information table, thereby to confirm the user name 1701, the view terminal 1702 and the registration terminal 1703. The user terminal A 4a displays a menu 1803 from the application management unit 1. When the terminal addition is selected from within the menu, the user terminal A 4a transmits a request 1804 for the additional terminal registration, to the application management unit 1. In the application management unit 1, an additional tentative ID associated with the above user name 1701 is generated and is recorded in the user information table, and the additional tentative ID is transmitted to the user terminal A 4a by a step 1805. The additional tentative ID is displayed in the user terminal A 4a, and the user performs the addition of the terminal with the additional tentative ID.

Using the terminal B 4b which is to be added anew, the user logs into the application management unit 1 with the additional tentative ID by a step 1821. The completion of the log-in is notified to the terminal B 4b by a step 1822. Simultaneously, the step 1822 makes a request for the terminal type 1703a of the terminal B 4b to-be-added. The terminal B 4b transmits the terminal identification, the identification sign of the terminal, etc. to the application management unit 1. Incidentally, the application management unit 1 may well generate the formal terminal identification sign 1703b associated with the user name 1701, on the basis of the information of the user terminal B 4b to-be-added as has been acquired at a step 1824, and it may well issue the identification sign 1703b simultaneously with the confirmation of the registration contents at a step 1825. In the user terminal B 4b, the registration contents are confirmed, and the approval of the registration contents is notified to the application management unit 1 by a step 1826. In the application management unit 1, it is confirmed by the step 1826 that the user's approval has been obtained, and the user information table is updated. By way of example, the application management unit 1 stores the terminal type and identification number of the registration terminal in correspondence with the user name. The completion of the update of the user information table is transferred to the user terminal B 4b by a step 1827, and the registration of the additional terminal is completed.

In the above example, the tentative ID of the additional terminal to be transferred by the step 1805 and to be displayed on the terminal A 4a can also be displayed by a two-dimensional bar code or the like, together with information such as an address which is to be accessed from the additional terminal, and user's convenience in the case of utilizing a portable telephone as the user terminal B 4b, etc. can be enhanced.

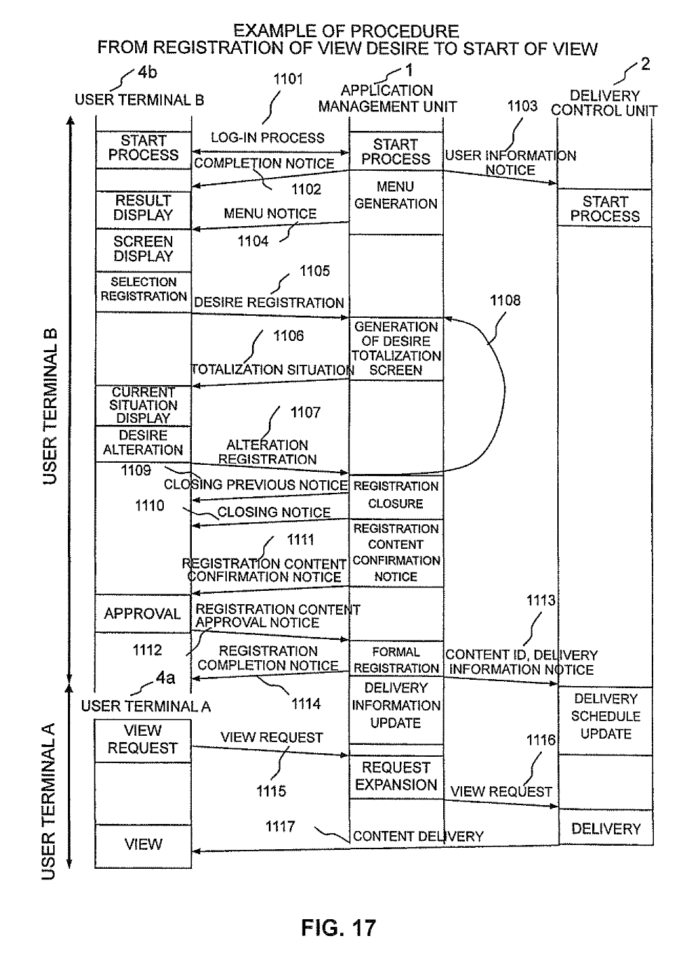

FIG. 17 is a sequence diagram showing a procedure from the registration of a view desire to the start of a view in this embodiment. Although the basic procedure is the same as in FIG. 3, steps 1101 to 1114 for registering the view desire are executed by the user terminal B 4b.

The view of a program is performed with the user terminal A 4a. After the log of the user terminal A 4a into the application management unit 1 (omitted from the illustration of FIG. 17), a view request is issued by a step 1115, and it is transferred to the delivery control unit 2 as a view request 1116 by the application management unit 1. Thereafter, the program is delivered by a step 1117 and can be viewed with the user terminal A 4a.

By way of example, when the application management unit 1 receives the view request 1115 from the user terminal A 4a, it acquires the user name (or user ID) corresponding to the user terminal A 4a, with reference to the view terminal of the user information table. The application management unit 1 acquires data corresponding to the acquired user name, for example, a content ID and a view time, with reference to the user view table, and it transmits the view request 1116 to the delivery control unit 2.

The present invention is applicable to, for example, a video-on-demand system.

What is claimed is:

1. A video-on-demand system which accepts view applications of a content from terminals and which delivers the content to the terminals, comprising:
a delivery information storage area in which a content identifier, a plurality of view times for the content, and a plurality of prices corresponding to the number of view applications for each content identifier and each view time are stored beforehand; and
an application management function portion which evaluates the price of the content on the basis of the number of view applications from the terminals,
wherein said application management function portion:
receives view application information items each of which contains the content identifier of the content desired to be viewed, and the view time desired to be viewed, from a plurality of the terminals;
totalizes the view application information items from the plurality of terminals, thereby to evaluate the number of view applications for each content identifier and each view time;
refers to said delivery information storage area on the basis of the content identifier and the view time, so as to obtain the price conforming to the number of view applications among the plurality of prices which correspond to the content identifier and the view time;
transmits the content identifier in said delivery information storage area, the plurality of view times for the content, and the obtained price of the content identifier and each view time, to the terminals or other terminal; and
receives an alteration request from at least a part of the terminals or the view application information from the other terminal.

2. A video-on-demand system as defined in claim 1, wherein
said delivery information storage area contains first to Nth threshold values (N being an integer) of the number of view applications, a first price in a case where the number of view applications is, at most, the first threshold value, and an (i+1) th price in a case where the number of view applications is larger than an ith threshold value (i being any integer of 1 to (N−1)) and is, at most, an (i+1)th threshold value, for each content identifier and each view time.

3. A video-on-demand system as defined in claim 2, wherein said application management function portion:
evaluates a jth price (j being any integer of 1 to N) conforming to the number of view applications, on the basis of the first to Nth threshold values in said delivery information storage area, and the obtained number of view applications;
evaluates the number of applications necessary for selecting the (j+1) th price, by taking a difference between the number of view applications and the jth threshold value; and
further transmits the number of view applications, the obtained jth price, and the number of the necessary applications, to the terminal or the other terminal.

4. A video-on-demand system as defined in claim 2, further comprising
a timepiece which measures a predetermined time period;
wherein said application management function portion obtains the number of view applications within the time period measured by said timepiece, and increases the ith threshold value in said delivery information storage area when the obtained number of view applications within the time period exceeds a predetermined value.

5. A video-on-demand system as defined in claim 1, wherein
said application management function portion transmits alternative measure information to the terminal from which the view application has been received, when the obtained number of view applications exceeds a predetermined threshold value.

6. A video-on-demand system as defined in claim 5, wherein
the predetermined threshold value is set in accordance with a system capability, and is a value for permitting the content to be viewed without degrading a video quality and a service quality thereof.

7. A video-on-demand system as defined in claim 5, wherein said application management function portion:
acquires another view time corresponding to the content identifier, by referring to said delivery information storage area on the basis of the content identifier and the view time which are contained in the view application information;
obtains the price which corresponds to the content identifier and the other view time; and
transmits the alternative measure information which contains the other view time and the price, to the terminal from which the view application has been received.

8. A video-on-demand system as defined in claim 1, wherein
said application management function portion raises the price of the content to be presented to the view desiring person, when the obtained number of view applications exceeds a predetermined threshold value.

9. A video-on-demand system as defined in claim 1, further comprising:
a totalization information storage area in which the price obtained on the basis of the number of view applications is stored in correspondence with the content identifier and the view time;
wherein said application management function portion stores the obtained price in said totalization information storage information in correspondence with the content identifier and the view time.

10. A video-on-demand system as defined in claim 1, wherein
the terminal with which a user transmits the view application, and the terminal with which the user views the content are not identical.

11. A video-on-demand system as defined in claim 1, wherein
the terminal which the user uses for the registration of his/her view desire is a portable telephone.

12. A video-on-demand system as defined in claim 1, wherein the content is delivered in multicast fashion.

13. A video-on-demand system as defined in claim 5, wherein:
in a case where view times of a plurality of contents overlap in a certain time zone, said application management function portion totalizes the respective numbers of view applications for the plurality of contents, thereby to obtain the total number of view applications in the time zone, and it transmits alternative measure information to the terminal from which the view applications have been received, when the total number of view applications exceeds the predetermined threshold value.
